(19) United States
(12) Patent Application Publication
(10) Pub. No.: US 2011/0000134 A1
(43) Pub. Date: Jan. 6, 2011

(54) HOLDBACK MECHANISM

(76) Inventor: Gerald Joseph Thibeault, Brampton (CA)

Correspondence Address: VOLPE AND KOENIG, P.C., UNITED PLAZA, 30 SOUTH 17TH STREET, PHILADELPHIA, PA, 19103, US

(21) Appl. No.: 12/496,291

(22) Filed: Jul. 1, 2009

(51) Int. Cl. E05C 17/02; E05C 17/04; E05C 17/36

(52) U.S. Cl. 49/70; 292/262; 49/506

(57) ABSTRACT

A holdback mechanism is provided. The holdback mechanism includes an elongate open body having a passage and a collar. A rod extends through the body and has a first end and a second end, with an anchor element extending from the first end. A biasing member is interposed between the rod and the body and biases the rod in a first direction to draw the anchor element within the passage.

### FIELD OF INVENTION

The disclosure relates generally to a holdback mechanism, and more particularly, to a holdback mechanism for securing a door or gate in an opened or closed position. The holdback mechanism may be used to hold a hinged door of a cargo truck or trailer in a selected position.

### BACKGROUND

Cargo trucks and trailers are often provided with hinged doors that pivot on vertical axes. These doors are commonly referred to as “swing doors” or “barn doors.” Such doors are typically provided at the rear of the vehicle, but may also be found at other locations such as a side or front wall of a cargo compartment of the vehicle. Trucks and trailers are typically backed into a loading dock with the door in the opened position. A door holdback is typically provided to hold the door in an opened position, while restraining movement thereof to prevent the door from swinging freely while the vehicle is in motion. Holdbacks are often positioned on a lower portion of a sidewall of the vehicle, and protrude from the side of the vehicle. Many known holdbacks fail to properly restrain the door when the vehicle travels across rugged terrain, or are difficult or confusing to secure properly, resulting in failure, and creating a risk of accidents caused by swinging of the door.

### SUMMARY

The disclosed holdback mechanism includes an elongate open body having a passage and a collar. A rod extends through the body and has a first end and a second end, with an anchor element extending from the first end. A biasing member is interposed between the rod and the body and biases the rod in a first direction to draw the anchor element within the passage.

### BRIEF DESCRIPTION OF THE DRAWINGS

FIG. 1 is a perspective view of a cargo truck having a swing door retained in an opened position with a holdback mechanism;

FIG. 2 is an exploded perspective view of a first embodiment of the holdback mechanism;

FIG. 3 is a perspective view of the holdback mechanism of FIG. 2 in a relaxed position;

FIG. 4 is a perspective view of the holdback mechanism of FIG. 2 in a tensioned position;

FIG. 5 is a longitudinal cross section of the holdback mechanism of FIG. 2 in the relaxed position and mounted to a lower main rail of a cargo truck or trailer;

FIG. 6 is a perspective view of the holdback mechanism as shown in FIG. 5, with the lower rail shown partially cut away;

FIG. 7 is a perspective view of a second embodiment of the holdback mechanism having a pneumatic actuator and in a relaxed position;

FIG. 8 is a perspective view of the holdback mechanism of FIG. 7, with the body shown partially cut away; and

FIG. 9 is a longitudinal cross section of the holdback mechanism of FIG. 7.

### DETAILED DESCRIPTION OF THE PREFERRED EMBODIMENTS

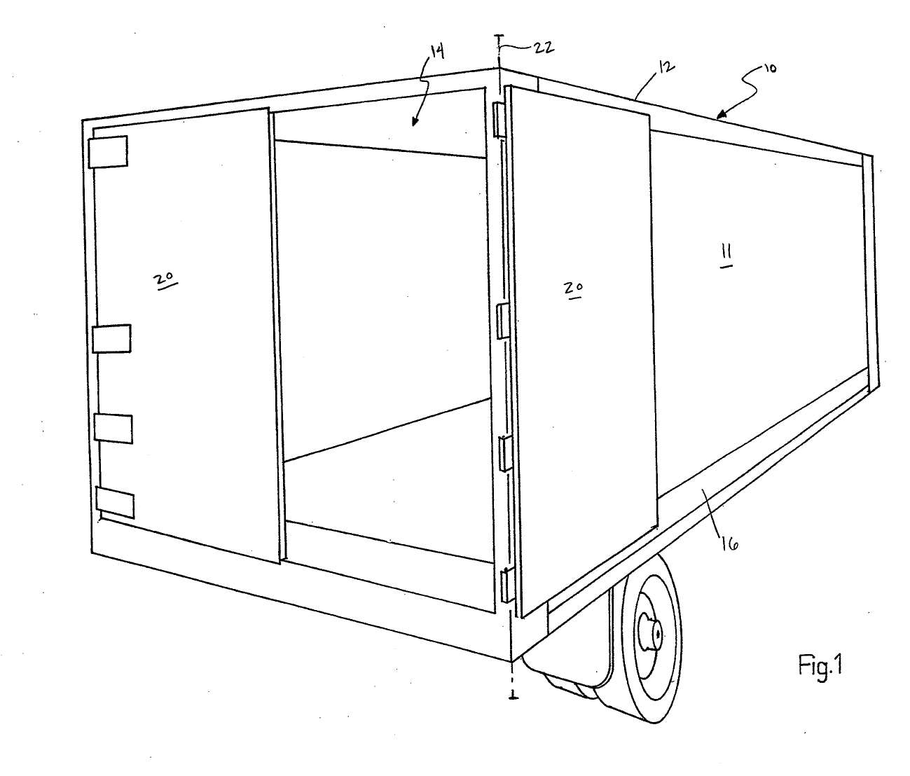

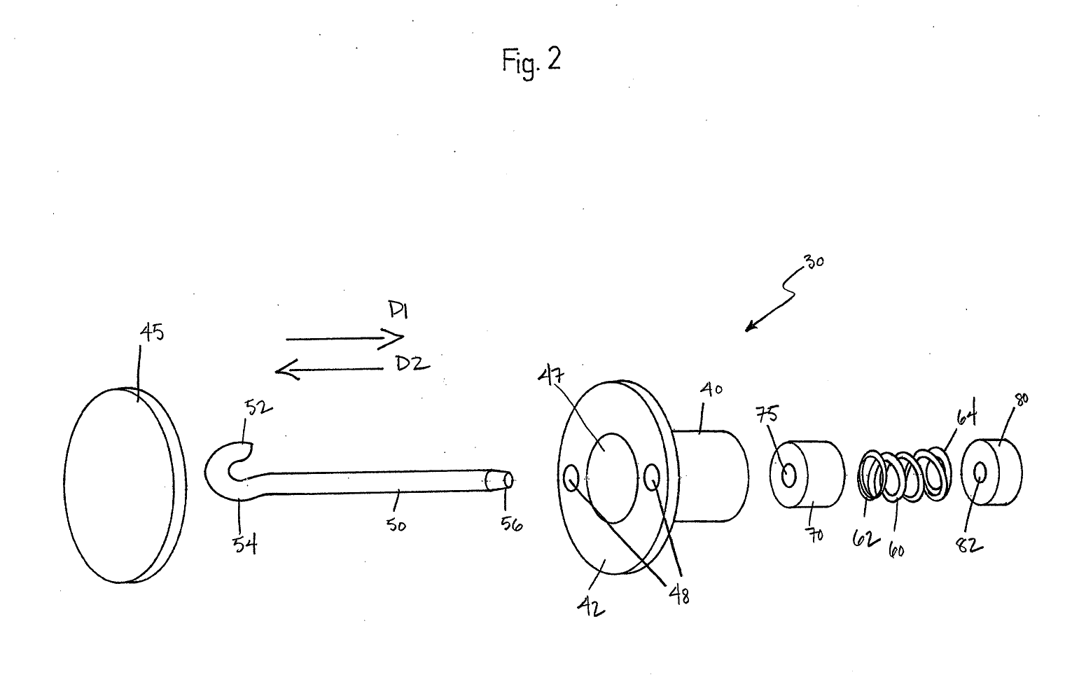

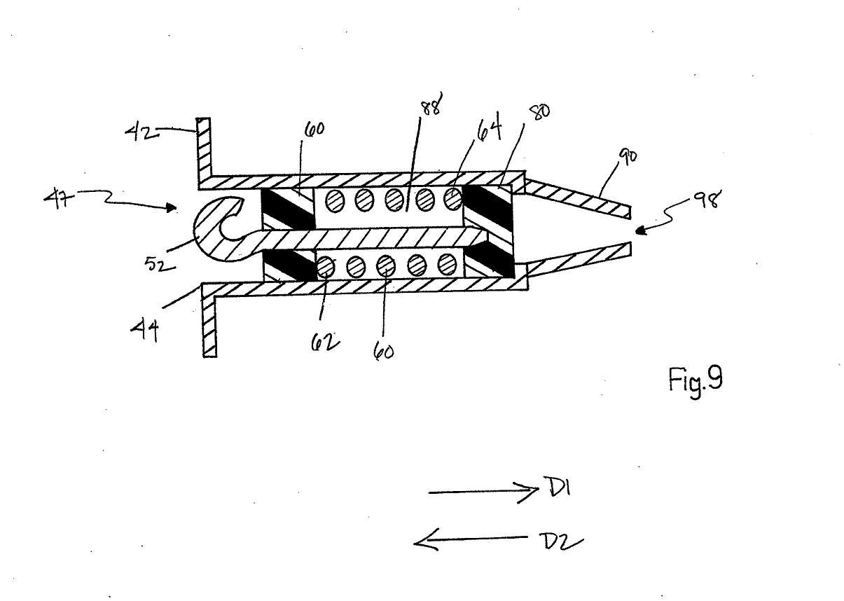

FIG. 1 shows a typical cargo truck 10 having a swing door 20. The door 20 is pivotally connected to a cargo compartment 12 of the truck 10 to open and close over an opening 14 defined therein. The door 20 pivots about a vertical axis 22 to move between opened and closed positions. The door 20 is shown in the opened position in FIG. 1. As shown, the door 20 pivots to a position adjacent to a side wall 11 of the cargo compartment 12. A holdback mechanism 30, such as that shown in FIGS. 2-8 and described in detail below, is affixed to the lower main rail 16, and retains the door 20 in the opened position adjacent to the side wall 11, to prevent it from swinging freely, which may occur, for example, when the truck 10 is in motion. Although the holdback mechanism 30 is shown and described for use with a swing door 20 of a cargo truck 10, a person of ordinary skill in the art would understand that the holdback mechanism 30 could be used in a variety of door assemblies, as well as other assemblies requiring movement between two structures to be restrained. As used hereinafter in the description and claims, the term “door” is defined as any type of barrier that moves between a closed position in which it completely or partially covers an opening, and an opened position in which the opening is left exposed. The definition should be understood as applicable to various types of structures including, but not limited to buildings, gates, cabinets, and the like.

A first embodiment of the holdback mechanism 30 is shown in FIGS. 2-6. As shown, the holdback mechanism 30 includes an elongate open body 40 including a passage 47. In the embodiment shown, the body 40 has a cylindrical tubular shape, but other types of elongate open structures can be employed as well.

Still referring to FIGS. 2-6, the body 40 includes a collar 42. In the illustrated embodiment, the collar 42 is a radially extending flange, located at a first end 44 of the body. The collar 42 is provided to facilitate mounting of the holdback mechanism 30, as described in further detail below. As shown in FIG. 2, a cover 45 that fits over the collar 42 may be provided. The cover 45 is placed over the collar 42 when the holdback mechanism 30 is not in use, and prevents debris from entering the passage 47. The cover 42 may be affixed over the collar by any known means, such as threading or a snap fitting.

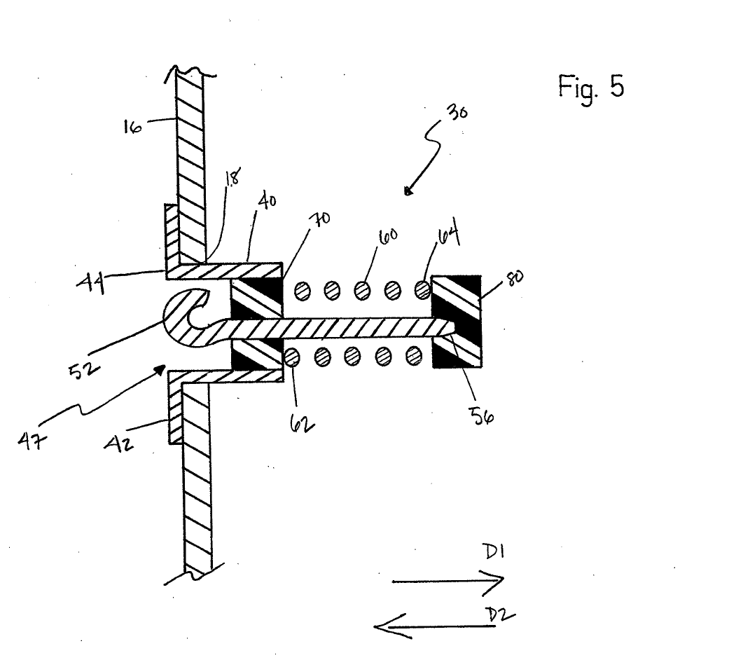

The holdback mechanism 30 further includes a rod 50, best shown in FIGS. 2 and 5. The rod 50 extends through passage 47 in body 40, and has an anchor element 52 extending from first end 54. The anchor element 52 as shown is a hook; however, other structures such as a chain link may also be employed.

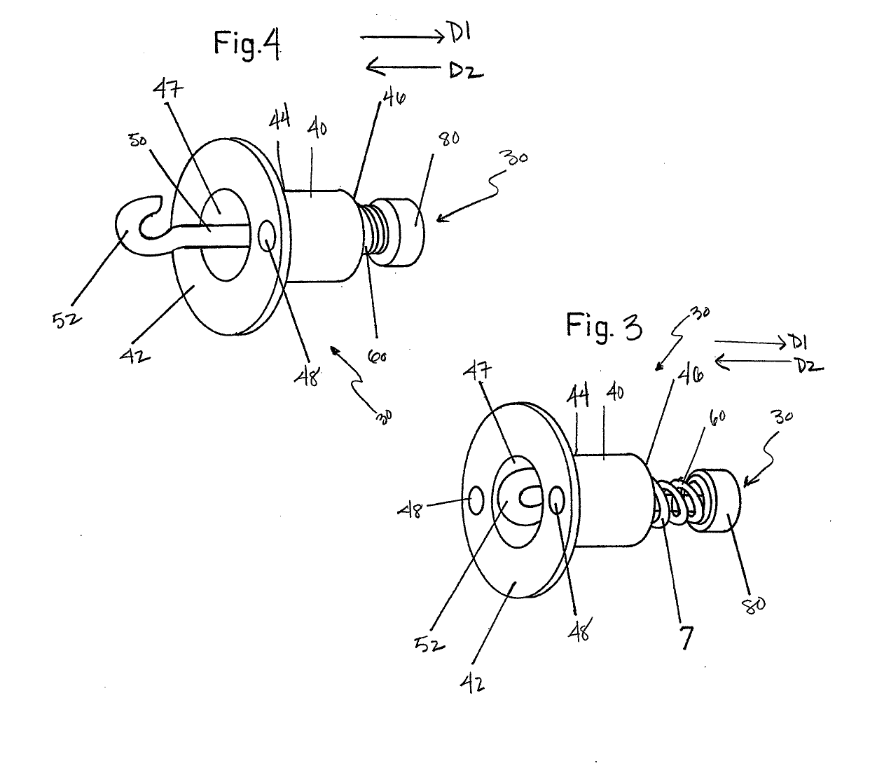

As shown in FIGS. 2-6, a biasing member 60 is interposed between the rod 50 and the body 40, and biases the rod 50 in a direction D1, such that a second end 56 thereof is at a position displaced from the body 40, shown in FIGS. 3, 5, and 6, in which the biasing member 60 is in a relaxed state. FIG. 4 shows the biasing member 60 in a compressed state. The second end 56 of the rod 50 is closer to the body 40 than when the biasing member 60 is relaxed. The biasing member 60 may be any type of spring or other device that exerts a biasing force on the rod 50 in the direction D1. In the embodiment shown, the biasing member 60 is a helical spring that extends around rod 50.

A bushing 70 is affixed within the passage 47 and adjacent to a first end 62 of the biasing member. The rod 50 slidably extends through a passage 75 defined in the bushing 70. In the embodiment of FIGS. 2-6, the biasing member 60 contacts the bushing 70, and extends from a second end 46 of the body 40.

Still referring to FIGS. 2-6, an end cap 80 contacts a second end 64 of the biasing member 60. The end cap 80 defines a recess 82 that receives a second end 56 of the rod 50, and is attached thereto, for example, by welding or engaging threadings formed on the second end 56 of the rod 50 and within the recess 82.

The holdback mechanism 30 moves between a relaxed position, shown in FIGS. 3, 5, and 6, and a tensioned position, shown in FIG. 4. Referring first to FIGS. 3, 5, and 6, the biasing member 60 is relaxed, biasing the end cap 80 and second end 56 of the rod 50 axially away from the body 40, and anchor element 52 to a position within the passage 47. When force is applied to the end cap 80 in direction D2, the end cap 80 is pushed towards the body 40, the biasing member 60 compressed between the bushing 70 and the end cap 80, and the anchor element 52 is pushed outward from the passage 47. In FIG. 4, the anchor element 52 is fully exposed, and can be affixed to an outside structure. Once the force is released from the end cap 80, the anchor element 52 is drawn back within the passage 47 as the biasing member 60 relaxes and expands.

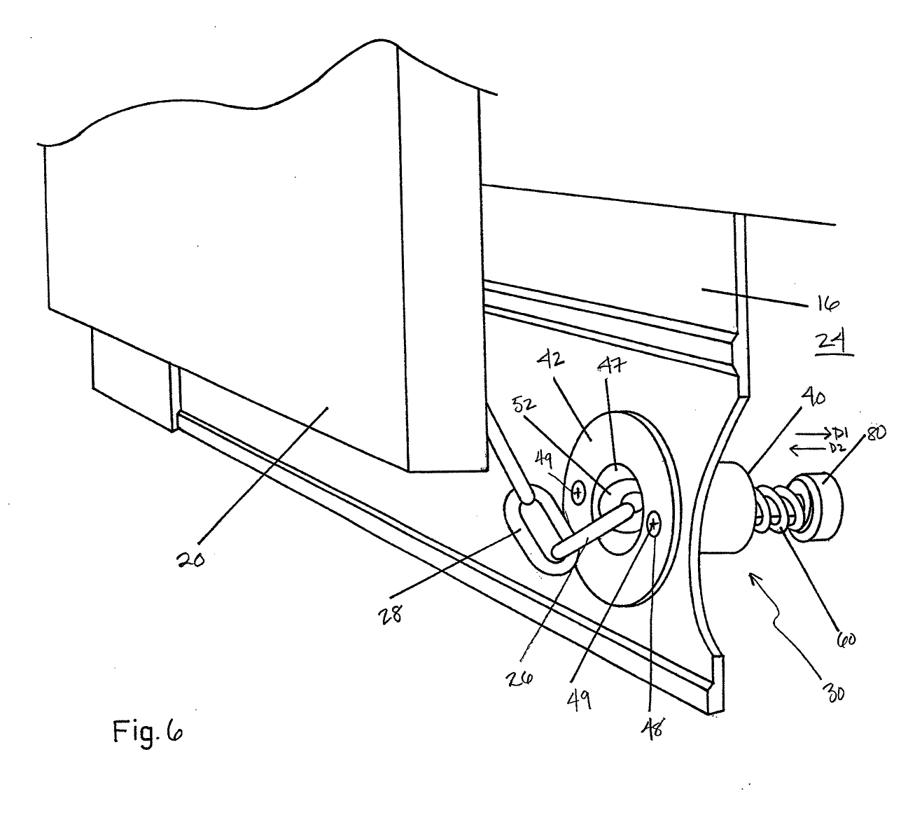

FIGS. 5 and 6 show the mounting of the holdback mechanism 30 to a lower main rail 16 of a truck or trailer 10 body. In the embodiment shown, the collar 42 includes holes 48 that receive fasteners 49, such as screws, that engage the lower rail 16 to fasten the collar 42 thereto. Other means of fastening may include welding, adhesives, or other types of mechanical fasteners. As shown, the collar 42 is mounted flush against an outer surface of the lower rail 16, with the body 40 extending through an opening 18 defined in the lower rail 16. As a result, the main working components of the holdback mechanism 30, including the body 40, biasing member 60, and a substantial portion of the rod 50, are tucked behind a mounting surface, in this case the lower rail 16, and housed within an interior area 24 of the lower rail 16, preventing them from protruding from an outside surface of the truck 10.

FIG. 6 shows the anchor element 52 affixed to a second anchor element 26. As shown, the second anchor element 26 may be a link of a chain 28 extending from a door 20. The chain 28 restrains movement of the door 20 when in an opened position, to prevent it from swinging freely about. As shown, the second anchor element 26 is partially drawn into the passage 47 of the body 40 to prevent disconnection from the first anchor element 52. When it is desired to release the connection between the anchor elements 26, 52, force is again applied to the end cap 80 in direction D2, exposing both anchor elements 26, 52, to permit manual disconnection.

In an alternative embodiment to that shown in FIGS. 5 and 6, the holdback mechanism 30 may be used to retain a door 20 in a closed position. In this embodiment, the holdback mechanism 30 is mounted to a surface of the doorway, and the chain 28 may be shortened or omitted. The rod 50 and biasing member 60 could also be lengthened, such that the entire length of the chain 28 is drawn into the body 40 when the holdback mechanism 30 is in the relaxed position, thus preventing any, or almost any movement of the door 20 away from the doorway or other structure that the holdback mechanism 30 is mounted to.

In yet another embodiment, the holdback mechanism 30 could be mounted to a door 20, such as that of the cargo truck or trailer 10 shown above, and the chain 28 or second anchor element 26 could be mounted to the lower rail 16 or other structure, to secure the door 20 in a selected position.

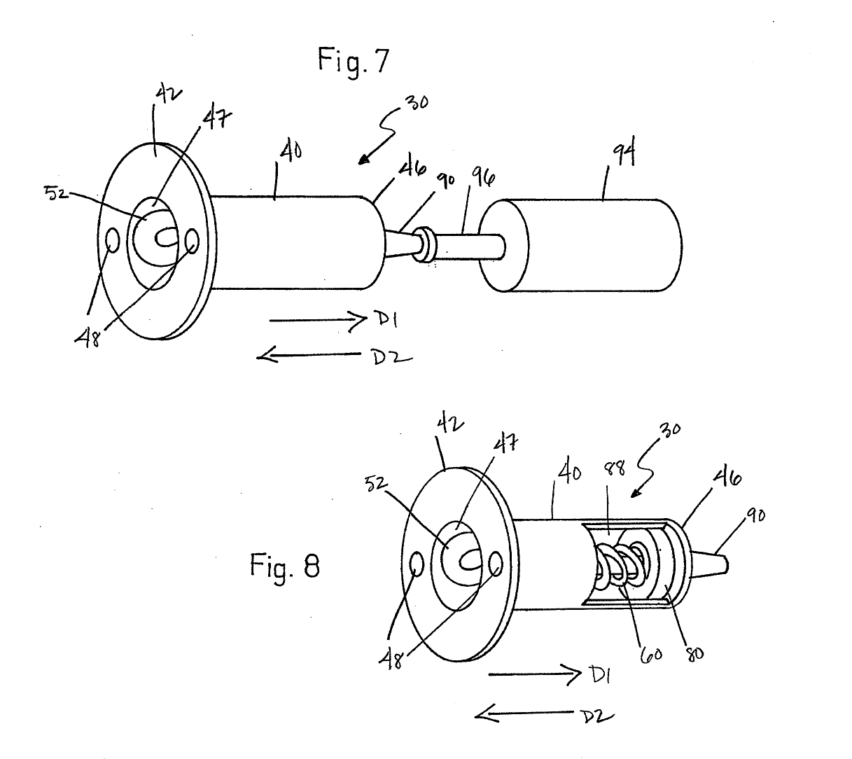

A further embodiment of the holdback mechanism 30 shown in FIGS. 7-9 is provided with actuation means, such that force need not be manually applied to the end cap 80 to expose the anchor element 52. As shown, this embodiment differs from that described above in that the body 40 is lengthened, such that it houses the end cap 80, biasing element 60, and the rod 50. A nipple 90 is provided at the second end 46 of the body 40 to facilitate attachment to outside actuation means, such that the body 40 is essentially enclosed, and defines an interior region 88 between the nipple 90 and the bushing 70. In the embodiment shown, the outside actuation means is an air bladder 94, shown in FIG. 7. The air bladder 94 may be directly attached to an end of the nipple 90, which includes an opening 98, or as shown in FIG. 7, a hose 96 may connect the two. This may be achieved, for example, by a threaded connection between the nipple 90 and the hose 96 or air bladder 94.

The air bladder 94 may be actuated by any means known in the art. An actuation device, such as a switch or button is preferably provided in an easily accessible location on the truck or trailer 10. When the bladder 94 is actuated, compressed air is forced through the nipple 90 and into the interior region 88 of the body 40. The air forces the end cap 80 in direction D2, causing it to slide within the interior region 88 of body 40, acting as a pneumatic piston. Alternative actuation means, such as a hydraulic bladder, may be provided in conjunction with the embodiment shown in FIGS. 7-9. Other variations would be within the purview of one skilled in the art and should be considered within the scope of the invention.

The components of the holdback mechanism 30 can be made of various materials. The bushing 70 and end cap are preferably made of polymeric materials, such as polyoxymethylene, commonly sold under the trade name DELRIN®, or nylon, but may also be made of other materials such as metals. The rod 50 and biasing member 60 are preferably made of stainless steel, and the body 40 is preferably made of powder coated steel, but these components may also be made of other metals or polymeric materials. The invention should not be considered limited to any particular type of material or materials used to form the components.

While the preferred embodiments of the invention have been described in detail above, the invention is not limited to the specific embodiments described, which should be considered as merely exemplary. Although the invention has been described for use in a door assembly of a cargo truck or trailer, it should be understood that it is not limited to such, and can be implemented into any type of door assembly, or other assembly that requires limiting movement between two structures thereof. For example, one embodiment is foreseen in which the holdback mechanism 30 is used for mooring of a boat to a dock. Additionally, although features and elements are described above in particular combinations, each feature or element can be used alone without the other features and elements or in various combinations with or without other features and elements.

What is claimed is:

1. A holdback mechanism, comprising:
an elongate open body having a passage and a collar;
a rod extending through the body and having a first end and a second end, an anchor element extending from the first end; and
a biasing member interposed between the rod and the body that biases the rod in a first direction to draw the anchor element within the passage.

2. The holdback mechanism of claim 1, wherein the body defines a tubular shape.

3. The holdback mechanism of claim 1, wherein the biasing member is a spring.

4. The holdback mechanism of claim 3, wherein the spring is a helical spring that extends around the rod.

5. The holdback mechanism of claim 1, further comprising an end cap affixed to the second end of the rod, and a busing affixed within the body, wherein the biasing member extends between the busing and the end cap and forces the end cap in the first direction, to draw the anchor element within the passage.

6. The holdback mechanism of claim 5, wherein the biasing member has a first end affixed to the bushing, and a second end affixed to the end cap.

7. The holdback mechanism of claim 5, wherein the rod slidably extends through the bushing.

8. The holdback mechanism of claim 1, wherein the rod moves between a first position wherein the biasing member is relaxed and the anchor element is within the passage, and a second position wherein the biasing member is compressed and the anchor element extends outside of the passage.

9. The holdback mechanism of claim 1, wherein the anchor element is a hook.

10. The holdback mechanism of claim 1, wherein the collar includes at least one hole that receives a fastener.

11. The holdback mechanism of claim 1, wherein the collar extends radially from the body.

12. The holdback mechanism of claim 1, further comprising an end cap affixed to the second end of the rod and slidably disposed within the passage, wherein the biasing member forces the end cap in the first direction, to draw the anchor element within the passage.

13. The holdback mechanism of claim 12, further comprising an actuator that drives the end cap in a second direction, to push the anchor element out from the passage.

14. The holdback mechanism of claim 13, further comprising a nipple affixed to an open end of the body to feed compressed air from the actuator into the passage and drive the end cap in the second direction.

15. A door assembly, comprising:
a structure defining an opening;
a door that opens and closes the opening; and
a holdback mechanism that restrains movement of the door away from the structure, the holdback mechanism comprising an elongate open body having a passage and a collar, a rod that extends through the body and has a first end and a second end, a first anchor element that extends from the first end, and a biasing member interposed between the rod and the body that biases the rod in a direction to draw the first anchor element within the passage;
wherein the holdback mechanism is mounted to a first one of the door or the structure, and a second anchor element that attaches to the first anchor element is affixed to a second one of the door or the structure.

16. The door assembly of claim 15, wherein the structure is a cargo truck or trailer.

17. The door assembly of claim 15, wherein the door pivots about an axis to open and close the opening.

18. The door assembly of claim 15, wherein the first one of the door or the structure comprises an outer surface, and the collar is mounted to the outer surface.

19. The door assembly of claim 18, wherein the body extends into an interior portion of the first one of the door or the structure.

20. The door assembly of claim 19, wherein the first anchor element is drawn into the interior portion of the first one of the door or the structure by the biasing member.

21. The door assembly of claim 18, wherein the collar includes at least one hole that receives a fastener to mount the collar to the outer surface.

22. The door assembly of claim 15, wherein the first anchor element is a hook.

23. The door assembly of claim 15, wherein the second anchor element is a chain link.

24. A method of restraining movement between a first structure and a second structure, comprising:
providing the first structure including a holdback mechanism, the holdback mechanism including an elongate open body having a passage and a collar, a rod that extends through the body and has a first end and a second end, a first anchor element that extends from the first end, and a biasing member interposed between the rod and the body that biases the rod in a first direction to draw the first anchor element within the passage;
providing the second structure including a second anchor element;
compressing the biasing member to push the first anchor element outward from the passage;
affixing the first anchor element to the second anchor element; and
releasing the biasing member to draw the first anchor element into the passage.
